(19) United States
(12) Patent Application Publication
(10) Pub. No.: US 2008/0283736 A1
(43) Pub. Date: Nov. 20, 2008

(54) OPTICAL ENCODER AND ELECTRONIC EQUIPMENT HAVING THE SAME

(76) Inventor: Norikazu OKADA, Kashihara-shi (JP)

Correspondence Address: BIRCH STEWART KOLASCH & BIRCH, PO BOX 747, FALLS CHURCH, VA, 22040-0747, US

(21) Appl. No.: 12/106,697

(22) Filed: Apr. 21, 2008

(30) Foreign Application Priority Data
May 17, 2007 (JP) 2007-131662

(51) Int. Cl. G01D 5/34

(52) U.S. Cl. 250/231.1

(57) ABSTRACT

In the optical encoder, the DC signal to be subjected to comparison is one for the first AC signal outputted from the second current-voltage converting part and the second AC signal outputted from the fourth current-voltage converting part, so that the DC signal is used in common. Therefore, it becomes possible to reduce the light-receiving area for the DC signal. In concrete, a total (⅝)P of the widths (⅛)P of the first through fifth light-receiving elements can be made narrower than one pitch P of the moving object. Moreover, by using in common the DC signal that becomes a comparison signal, the influences of the scattering, variation and so on of light can be reduced, and variations in the signals outputted from first and second differential amplifiers that constitute the comparing parts can be reduced.

### CROSS-REFERENCE TO RELATED APPLICATIONS

This Nonprovisional application claims priority under 35 U.S.C. §119(a) on Patent Application No. 2007-131662 filed in Japan on May 17, 2007, the entire contents of which are hereby incorporated by reference.

### BACKGROUND OF THE INVENTION

The present invention relates to optical encoders for detecting the position, moving velocity, moving direction and so on of a moving object by means of a light-receiving element and relates, in particular, to an optical encoder suitable for use in, for example, printing apparatuses such as copying machines and printers, FA (Factory Automation) equipment and the like.

Conventionally, there has been proposed an optical encoder as shown in FIG. 5A, in which a plurality of light-receiving elements 101 through 104 arranged at (¼) pitch are provided in the array direction of a slit 100A formed at a prescribed pitch P at a slit plate 100 as a moving object (refer to JP S59-40258 A). The optical encoder compares light-receiving signals outputted from the light-receiving elements 101 through 104 on which light from a light source is incident passing through the slit 100A and obtains highly reliable rotary information of the slit plate 100.

Moreover, according to the technique described in JP 2006-153753 A, an output signal from which the DC (Direct Current) signal component is removed is obtained by subtracting a signal component proportional to a summation value of output signals from the elements of two groups of mutually opposite phases from output signals of detection elements of four groups of which the phases are shifted at (¼) pitches.

For example, as shown in FIG. 5B, output signals S101′ through S104′ from which the DC (Direct Current) signal component have been removed are obtained by subtracting a signal component proportional to a summation value (S101+S103) obtained by summing up the output signal S101 of the light-receiving element 101 and the output signal S103 of the light-receiving element 103 (or a summation value (S102+S104) obtained by summing up the output signal S102 of the light-receiving element 102 and the output signal S104 of the light-receiving element 104) from the output signals S101 through S104.

Moreover, the technique described in JP 2006-138775 A discloses that, when the slit of the moving object has an arrangement pitch of one pitch, a DC (Direct Current) is monitored by a diode which has a scale width of the one pitch.

Moreover, the technique described in JP 2005-353630 A describes that the resolving power of the received light is changed by placing a lens on a light-receiving element.

Assuming that the arrangement pitch of the slit 100A of a moving object is one pitch P in an optical encoder, as generally shown in FIG. 5A, then the method of arranging four light-receiving elements 101 through 104 at an equal pitch, i.e. (¼) pitch is adopted.

However, since the width of the light-receiving elements 101 through 104 is increased in the case of use with coarse resolving power, the chip size of the light-receiving element is increased, and this leads to a cost increase. Moreover, the light-receiving area should desirably be smaller because the diffraction of light from the light-emitting side is reduced due to the resolving power made coarse and the SN ratio is also increased. It is herein noted that the coarse resolving power refers to a resolving power lower than general 150 LPI and 180 LPI.

Moreover, in the one example shown in FIG. 5A, the light-receiving elements 101 and 102 are arranged symmetrically to the light-receiving elements 103 and 104 in correspondence with the light-on portion (slit 100A) and the light-off portion (solid portion 100B). By taking a difference between the output signal of the light-receiving elements 101 and 102 and the output signal of the light-receiving elements 103 and 104 by the arrangement, the SN ratio is prevented from being reduced in a case where a DC component is generated in the output signal due to the diffraction and the like of light when each light-receiving element should be optically off.

Methods for obtaining the DC component of the output signal as described above include the method of obtaining antiphase signals by summation as in JP 2006-153753 A and the method of monitoring the DC component by a light-receiving element of a width corresponding to one pitch of the moving object as in JP 2006-138775 A. However, both the prior art techniques need a Large light-receiving area.

On the other hand, according to JP 2005-353630 A described above, the resolving power can be changed by the lens, and therefore, a reduction in the light-receiving area and a reduction in the size of the light-receiving element become possible. However, since the lens is needed as another component, the total cost including the optical system is increased.

As described above, a low-cost optical encoder capable of avoiding the reduction in the SN ratio due to the DC component caused by the diffraction of light when used particularly with low resolving power is demanded.

### SUMMARY OF THE INVENTION

An object of the present invention is to provide a compact low-cost optical encoder capable of avoiding the reduction in the SN ratio due to the DC component of the light-receiving signal.

In order to solve the above problems, the optical encoder of the present invention is an optical encoder having a light-emitting element, and a plurality of light-receiving elements arranged side by side in one direction in a region that light from the light-emitting element can reach, for detecting movement of a moving object, which has an light-on portion that produces a state in which the light is incident on the light-receiving elements when the light-on portion passes through a prescribed position corresponding to the light-receiving elements and an light-off portion that produces a state in which the light is incident on the light-receiving elements when the light-on portion passes through the prescribed position corresponding to the light-receiving elements, with the light-on portion and the light-off portion alternately passing through the prescribed position when moving in the one direction, the optical encoder comprising:

a first output part which outputs a DC signal comprised of a DC component by summing up two light-receiving signals whose phases are mutually different by 180° out of a plurality of light-receiving signals outputted from the plurality of light-receiving elements;

a second output part to which at least one light-receiving signal out of the plurality of light-receiving signals is inputted and which outputs an AC signal containing an AC component obtained from the inputted light-receiving signal; and

a comparing part to which the DC signal from the first output part and the AC signal from the second output part are inputted and which compares the DC signal with the AC signal and outputs a signal that represents a result of the comparison.

According to the optical encoder of the present invention, the comparing part compares the DC signal constituted of the DC component obtained by the first output part with the AC signal of the AC component obtained by the second output part and outputs the signal that represents the comparison result. The comparing part judges a magnitude correlation between the signal value of the AC signal and the signal value of the DC signal and outputs a signal that represents the comparison result.

Moreover, only one DC signal is necessary for the plurality of AC signals. That is, the DC signal can be used in common to the plurality of AC signals, and this therefore makes it possible to reduce the light-receiving area for the DC signal. Moreover, by using the DC signal in common, variation in the signal outputted from the comparing part can be reduced. Therefore, according to the present invention, a compact low-cost optical encoder capable of avoiding the reduction in the SN ratio due to the DC component of the light-receiving signal can be provided.

In the optical encoder of one embodiment, the second output part generates the AC signal by summing up the plurality of light-receiving signals.

According to the optical encoder of the present embodiment, the AC signal is generated by summing up a plurality of light-receiving signals. Thus, by making the light-receiving area of the light-receiving element that generates the AC signal identical or proportional to the light-receiving area of the light-receiving element that generates the DC signal, it becomes possible to balance the AC signal with the DC signal. Therefore, the variation in comparing the AC signal with the DC signal by the comparing part can be suppressed.

In the optical encoder of one embodiment, one light-receiving signal of the two light-receiving signals inputted to the first output part is inputted to the second output part.

According to the optical encoder of the present embodiment, one of the two light-receiving signals of the antiphase correlation for obtaining the DC signal is utilized as a light-receiving signal for obtaining the AC signal, and therefore, the area of the light-receiving element can be reduced. Moreover, variation in the quantity of received light attributed to the difference of the arrangement position of the light-receiving element can be suppressed, and variation in the duty ratio of the AC signal can be suppressed.

The optical encoder of one embodiment further comprises:

assuming n is an even number of not smaller than two, a number {(n/2)+1} of light-receiving elements arranged in a direction corresponding to the moving direction of the moving object, wherein

the light-receiving elements have a dimension in the direction corresponding to the moving direction of the moving object, the dimension being one n-th of an array pitch of the light-on portion and the light-off portion of the moving object, and

the first output part outputs the DC signal comprised of the DC component by summing up light-receiving signals outputted from two light-receiving elements located at opposite ends of the array of the number {(n/2)+1} of light-receiving elements.

According to the optical encoder of the present embodiment, assuming that the array pitch is P, then (1/n)P×1{(n/2)+1}=(1/2+1/n)P becomes the moving direction correspondence dimension (width) of the number {(n/2)+1} of light-receiving elements. That is, the total width of the number {(n/2)+1} of light-receiving elements can be reduced to a value close to the size that is one half of the array pitch P by increasing the value of n, and the light-receiving area can be reduced. Then, the two light-receiving signals outputted from the two light-receiving elements of 1/n width located at opposite ends of the array of the number {(n/2)+1} of light-receiving elements have the antiphase correlation of the mutual phase shift of 180°. Therefore, by summing up the two light-receiving signals in the first output part, the AC component is canceled to allow the DC signal constituted of the DC component to be obtained. By comparing the DC component with the signal component, a signal group having phase differences within a range of 0 to 180° can be obtained from the comparing part. It is noted that the value of n should desirably be determined within a range free from the influences of the variations in the signal circuit and the optical system in consideration of the light-receiving sensitivity of the light-receiving element.

In the optical encoder of one embodiment, the number n is an even number of not smaller than four,

the first output part outputs the DC signal by amplifying by (n/8) times a summation signal obtained by summing up the light-receiving signals, and

the second output part outputs the AC signal containing the AC component obtained from the light-receiving signals outputted from a number (n/4) of light-receiving elements out of a number (n/2) of light-receiving elements which are defined by excluding either one of the two light-receiving elements located at opposite ends of the array among the number {(n/2)+1} of light-receiving elements.

According to the optical encoder of the present embodiment, in the number (n/2) of light-receiving elements which are defined by excluding either one of the two light-receiving elements out of the light-receiving elements located at opposite ends of the array of the number {(n/2)+1} of light-receiving elements, the phase difference between the phase of the AC signal obtained from the number (n/4) of light-receiving elements and the AC signal obtained from the remaining a number (n/4) of light-receiving elements can be made 90°. Moreover, the first output part amplifies by (n/8) times the DC signal obtained by summing up the light-receiving signals of the two light-receiving elements of (1/n) width and outputs the resulting signal, while the second output part outputs the AC signal obtained from the number (n/4) of light-receiving elements of (1/n) width. That is, by the comparing part comparing the DC component of 2×(1/n)×(n/8)=(¼) pitch by the first output part with the AC component of (n/4)×(1/n)=(¼) pitch by the second output part, the signal of the duty ratio of 50% is obtained from the comparing part, and this is therefore advantageous in terms of signal processing.

In the optical encoder of one embodiment, at least one of the first and second output parts comprises a plurality of amplifiers and a current mirror circuit that distributes light-receiving signals to the plurality of amplifiers.

According to the optical encoder of the present embodiment, the first or second output part distributes the light-receiving signal to the plurality of amplifiers by the current mirror circuit. Therefore, the attenuation of the light-receiving signal and the interference between the plurality of light-receiving signals can be suppressed, so that the DC signal or the AC signal can be brought close to the ideal waveform.

Moreover, the electronic equipment of one embodiment, which has the above optical encoder, therefore becomes compact low-cost electronic equipment having an optical encoder that has excellent operation accuracy even if the quantity of received light fluctuates mainly when it is used with low resolving power and is able to output signals of small variations.

According to the optical encoder of the present invention, the comparing part compares the DC signal constituted of the DC component obtained by the first output part with the AC signal of the AC component obtained by the second output part and outputs the signal that represents the comparison result. For example, by subtracting the DC signal from the AC signal, an AC component as an effective signal component is obtained from the AC signal. Moreover, only one DC signal is necessary for the plurality of AC signals. That is, the DC signal can be used in common to the plurality of AC signals, and this therefore makes it possible to reduce the light-receiving area for the DC signal. Moreover, by using the DC signal in common, variation in the signal outputted from the comparing part can be reduced. Therefore, according to the present invention, a compact low-cost optical encoder capable of avoiding the reduction in the SN ratio due to the DC component of the light-receiving signal can be provided.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a block diagram showing the arrangement of light-receiving elements (light-receiving element width: ⅛ pitch) and the construction of a signal processing system according to a first embodiment of the optical encoder of the present invention;

FIG. 1B is a waveform chart showing one example of current waveforms outputted from first through fifth current distributors that have received light-receiving signals outputted from the light-receiving elements of the first embodiment;

FIG. 1C is a waveform chart showing one example of summation current waveforms inputted to first through fourth current-voltage converting parts of the first embodiment;

FIG. 2 is a block diagram showing the arrangement of light-receiving elements (light-receiving element width: ¼ pitch) and the construction of a signal processing system according to a second embodiment of the optical encoder of the present invention;

FIG. 3 is a block diagram showing the arrangement of light-receiving elements (light-receiving element width: 1/16 pitch) and the construction of a signal processing system according to a third embodiment of the optical encoder of the present invention;

FIG. 4 is a circuit diagram showing a circuit example in which the first through fifth current distributors are each constructed of a current mirror circuit in the first embodiment;

FIG. 5A is a schematic diagram showing a structural example of a conventional optical encoder; and

FIG. 5B is a waveform chart for explaining the output signals of the light-receiving elements of the conventional optical encoder and an example of signal processing therefor.

### DETAILED DESCRIPTION OF THE INVENTION

The present invention will be described in detail below by the embodiments shown in the drawings.

### First Embodiment

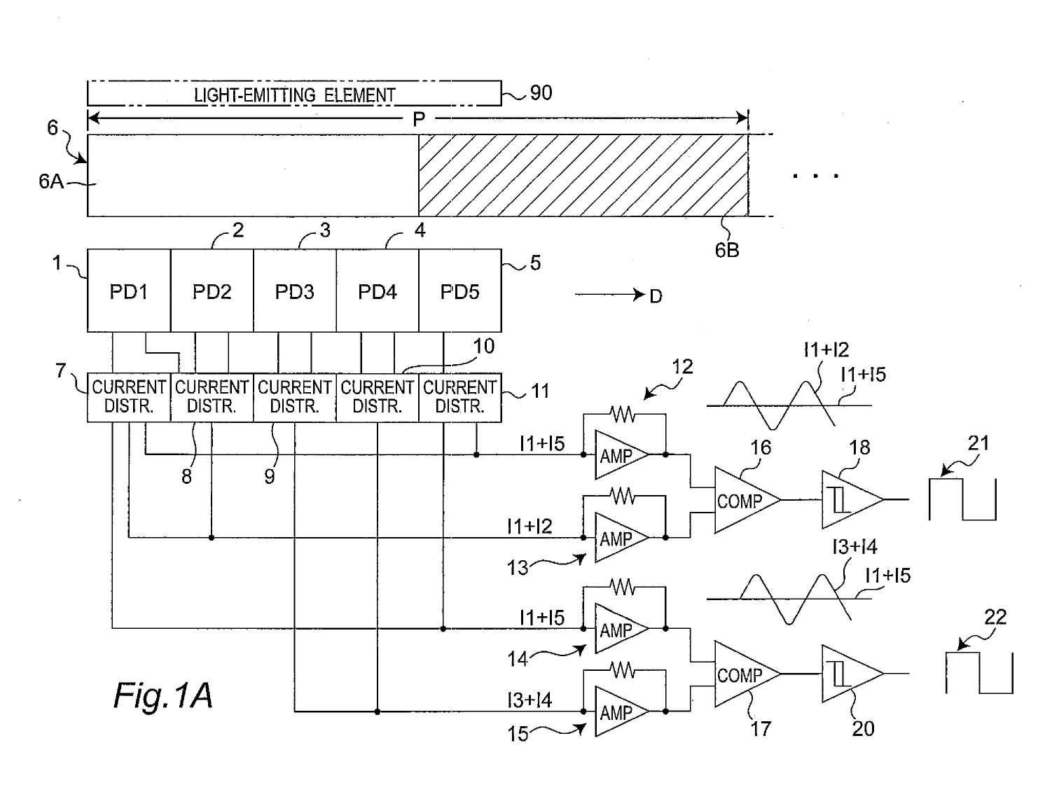

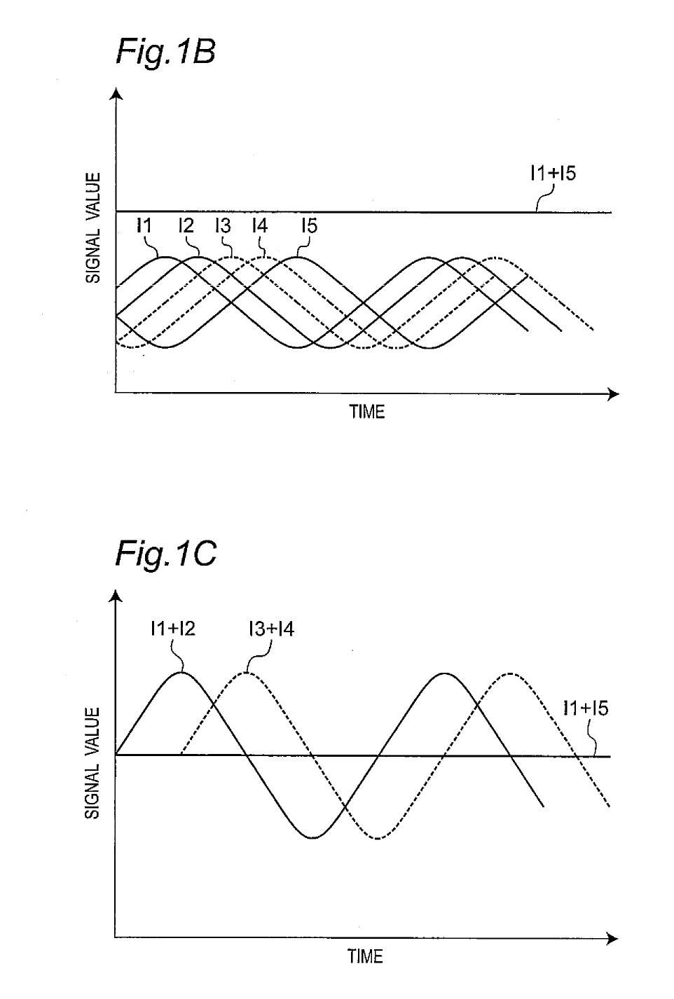

FIG. 1A schematically shows the construction of an optical encoder as the first embodiment of the present invention.

The first embodiment has a light-emitting element 90 and five light-receiving elements 1 through 5 arranged side by side in one direction in a region that light from the light-emitting element 90 can reach. The light-receiving elements 1 through 5 are each constructed of a photodiode as one example. These five light-receiving elements 1 through 5 and the light-emitting element 90 are arranged so that a moving object 6 is placed between them at prescribed spacing.

At the moving object 6, a slit 6A served as the light-on portion and a solid portion 6B served as the light-off portion are arranged alternately in its moving direction D. Light incident from the light-emitting element 90 on the slit 6A can pass through the slit 6A, whereas light incident on the solid portion 6B from the light-emitting element 90 cannot pass through the solid portion 6B. Although the dimension in the moving direction D of the slit 6A and the dimension in the moving direction D of the solid portion 6B are made equal to each other in the present embodiment, the dimensions of both of them may be different from each other. The five light-receiving elements 1 through 5 arranged in the direction corresponding to the moving direction D of the moving object 6 have a dimension (width) in a direction corresponding to the moving direction D, the dimension being one eighth of the array pitch P of the slit 6A of the moving object 6.

Moreover, the present embodiment has five first through fifth current distributors 7 through 11, four first through fourth current-voltage converting parts 12 through 15 as amplifiers, two first and second differential amplifiers 16 and 17 as comparing parts, and two first and second AD (analog-to-digital) converting parts 18 and 20. The first and fifth current distributors 7 and 11 and the first and third current-voltage converting parts 12 and 14 constitute a first output part. The first through fourth current distributors 7 through 10 and the second and fourth current-voltage converting parts 13 and 15 constitute a second output part.

Light-receiving signals outputted from the five light-receiving elements 1 through 5 are inputted to the five first through fifth current distributors 7 through 11, respectively. The first, second, third, fourth and fifth current distributors 7, 8, 9, 10 and 11 output first, second, third, fourth and fifth light-receiving currents I1, I2, I3, I4 and I5, respectively, by the light-receiving signals from the light-receiving elements 1, 2, 3, 4 and 5 as shown in FIG. 1B. The light-receiving signal outputted from the first light-receiving element 1 and the light-receiving signal outputted from the fifth light-receiving element 5 have phases that are mutually different by 180°, and therefore, the first light-receiving current I1 and the fifth light-receiving current I5 have phases that are mutually different by 180°.

The first light-receiving current I1 from the first current distributor 7 and the fifth light-receiving current I5 from the fifth current distributor 11 are inputted to the first current-voltage converting part 12 and the third current-voltage converting part 14. Therefore, a current (I1+I5) constituted of a DC component obtained by summing up the two first and fifth light-receiving currents I1 and I5 of which the phases are mutually different by 180° is inputted to the first and third current-voltage converting parts 12 and 14, and a DC signal obtained by converting the summation current (I1+I5) into a voltage is outputted to the first and second differential amplifiers 16 and 17. The first and third current-voltage converting parts 12 and 14 and the first and fifth current distributors 7 and 11 constitute the first output part. The summation current (I1+I5) corresponds to the waveform (I1+I5) shown in FIGS. 1B and 1C.

On the other hand, a summation current (I1+I2) as an AC component obtained by summing up the first and second light-receiving currents I1 and I2 from the first and second current distributors 7 and 8 is inputted to the second current-voltage converting part 13. Therefore, the second current-voltage converting part 13 converts the summation current (I1+I2) into a voltage and outputs a first AC signal containing an AC component to the first differential amplifier 16. The summation current (I1+I2) corresponds to the waveform (I1+I2) shown in FIG. 1C.

Moreover, a summation current (I3+I4) as an AC component obtained by summing up the third and fourth light-receiving currents I3 and I4 from the third and fourth current distributors 9 and 10 is inputted to the fourth current-voltage converting part 15. Therefore, the fourth current-voltage converting part 15 converts the summation current (I3+I4) into a voltage and outputs a second AC signal containing an AC component to the second differential amplifier 17. The summation current (I3+I4) corresponds to the waveform (I3+I4) shown in FIG. 1C.

The first differential amplifier 16 compares the DC signal from the first current-voltage converting part 12 with the first AC signal from the second current-voltage converting part 13 and outputs a signal of an amplified difference between both of them to the first AD converting part 18. The second differential amplifier 17 compares the DC signal from the third current-voltage converting part 14 with the second AC signal from the fourth current-voltage converting part 15 and outputs a signal of an amplified difference between both of them to the second AD converting part 20. As a result, the first AD converting part 18 outputs a first digital signal 21, and the second AD converting part 20 outputs a second digital signal 22.

According to the present embodiment, the two digital signals 21 and 22, of which the duty ratio is 50% and the phases are mutually different by approximately 90°, are obtained from the first and second AD converting parts 18 and 20. In the present embodiment, by equalizing the light-receiving areas of the first AC signal, the second AC signal and the DC signal, the duty ratio of the two digital signals 21 and 22 becomes 50%. Moreover, the first and second differential amplifiers 16 and 17 can perform the comparing operation without offsetting the first and second AC signals and the DC signal.

According to the present embodiment, the DC signal to be subjected to comparison is one for the first AC signal outputted from the second current-voltage converting part 13 and the second AC signal outputted from the fourth current-voltage converting part 15, so that the DC signal is used in common. Therefore, according to the present embodiment, it becomes possible to reduce the light-receiving area for the DC signal. In concrete, a total (⅝)P of the widths (⅛)P of the first through fifth light-receiving elements 1 through 5 can be made narrower than one pitch P of the moving object 6. Moreover, by using in common the DC signal that becomes a comparison signal, the influences of the scattering, variation and so on of light can be reduced, and variations in the signals outputted from the first and second differential amplifiers 16 and 17 that constitute the comparing parts can be reduced. Therefore, according to the present embodiment, a compact low-cost optical encoder capable of avoiding the reduction in the SN ratio due to the DC component of the light-receiving signal can be provided.

In the present embodiment, when there are differences in the distribution of the quantities of light incident on the light-receiving elements 1 through 5 from the light-emitting element 90, a DC signal of a value proportional to the signal value of the DC signal outputted from the current-voltage converting parts 12 and 14 may be inputted to the first and second differential amplifiers 16 and 17. Moreover, an AC signal of a value proportional to the signal value of the AC signal outputted from the current-voltage converting parts 13 and 15 may be inputted to the first and second differential amplifiers 16 and 17.

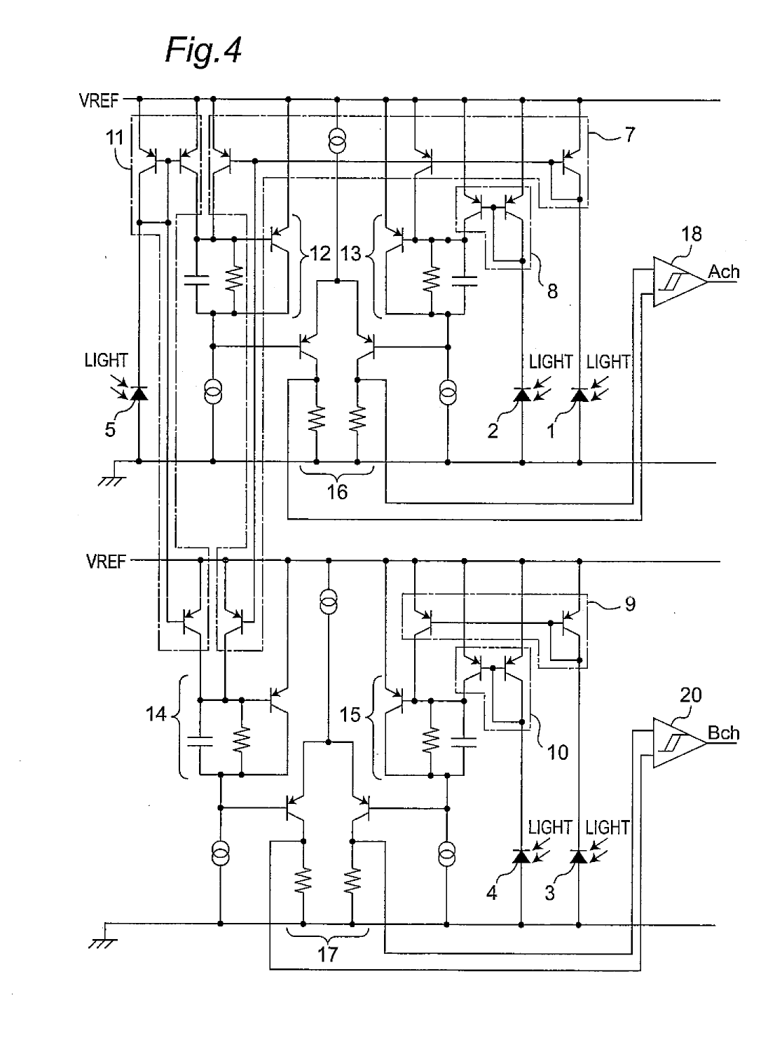

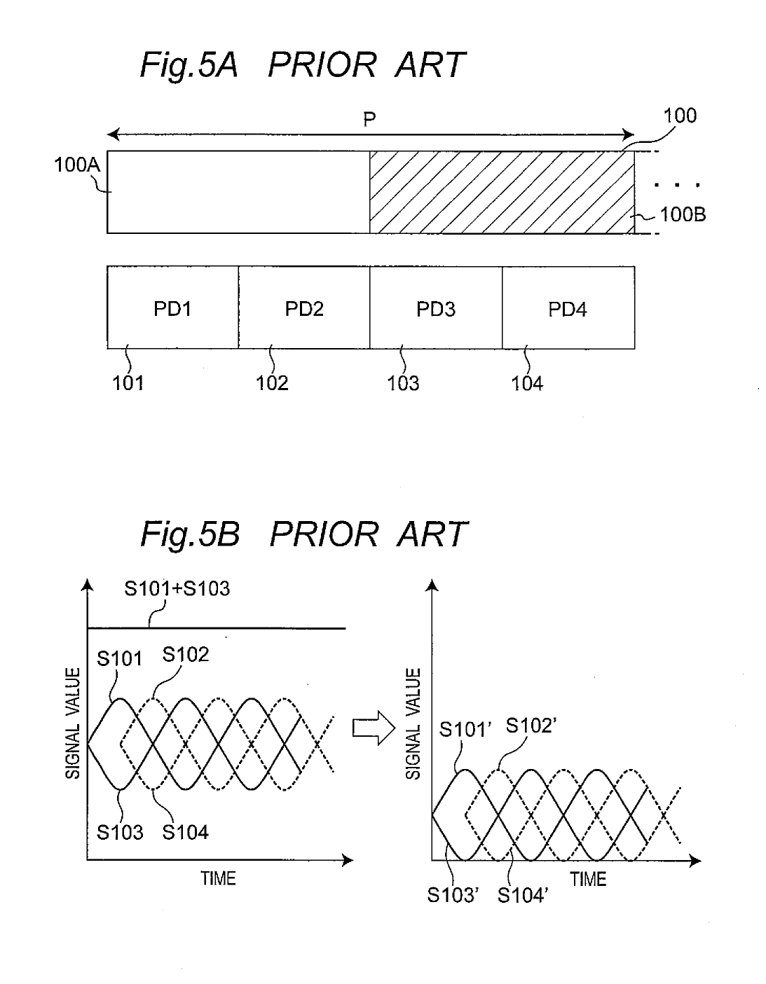

Next, FIG. 4 shows a circuit example corresponding to the first embodiment. The circuit example has first, second, third, fourth and fifth current distributors 7, 8, 9, 10 and 11 constituted of a current mirror circuit. By employing the current mirror circuit, a current attenuation due to the current distribution can be prevented. The light-receiving current I1 from the first current distributor 7 and the light-receiving current I5 from the fifth current distributor 11 are inputted to the current-voltage converting part 12, and a DC signal obtained by converting the summation current (I1+I5) of the sum of the light-receiving currents I1 and I5 into a voltage is inputted to the first differential amplifier 16. On the other hand, the light-receiving current I1 from the first current distributor 7 and the light-receiving current I2 from the second current distributor 8 are inputted to the current-voltage converting part 13, and a first AC signal obtained by converting the summation current (I1+I2) of the sum of the light-receiving currents I1 and I2 into a voltage is inputted to the first differential amplifier 16. The first differential amplifier 16 compares the DC signal with the first AC signal and outputs a signal of an amplified difference between both of them to the first AD converting part 18.

On the other hand, the light-receiving current I1 from the first current distributor 7 and the light-receiving current I5 from the fifth current distributor 11 are inputted to the current-voltage converting part 14, and a DC signal obtained by converting the summation current (I1+I5) of the sum of the light-receiving currents I1 and I5 into a voltage is inputted to the second differential amplifier 17. On the other hand, the light-receiving current I3 from the third current distributor 9 and the light-receiving current I4 from the fourth current distributor 10 are inputted to the current-voltage converting part 15, and a second AC signal obtained by converting the summation current (I3+I4) of the sum of the light-receiving currents I3 and I4 into a voltage is inputted to the second differential amplifier 17. The second differential amplifier 17 performs comparing operation of the DC signal with the second AC signal and outputs a signal of an amplified difference between both of them to the second AD converting part 20.

### Second Embodiment

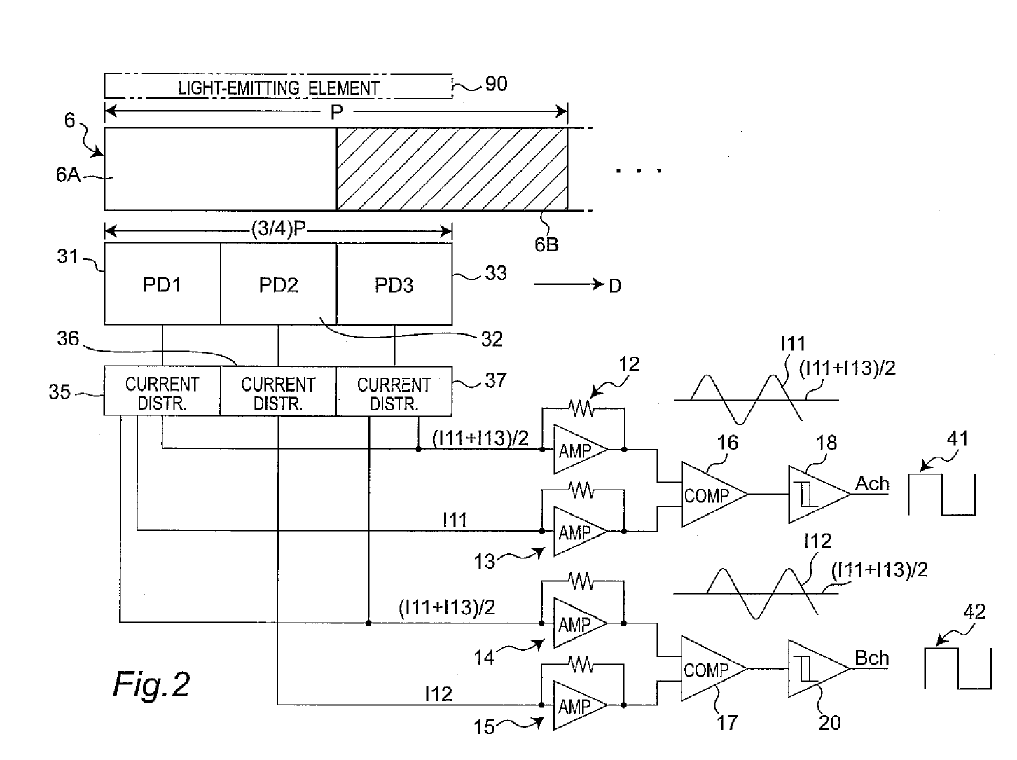

Next, FIG. 2 schematically shows the construction of an optical encoder as a second embodiment of the present invention. The second embodiment differs from the first embodiment in that three light-receiving elements 31 through 33 are provided in place of the five light-receiving elements 1 through 5 of FIG. 1A and that three current distributors 35 through 37 are provided in place of the five current distributors 7 through 11 of FIG. 1A. Therefore, components similar to those of the first embodiment are denoted by same reference numerals, and the points different from the first embodiment are mainly described.

In the present embodiment, the three light-receiving elements 31 through 33 arranged in the direction corresponding to the moving direction D of the moving object 6 have a dimension (width) in a direction corresponding to the moving direction D, the dimension being one fourth of the array pitch P of the slit 6A of the moving object 6.

Light-receiving signals outputted from the three light-receiving elements 31, 32 and 33 are inputted to the three first through third current distributors 35, 36 and 37, respectively. The first current distributor 35 outputs a first light-receiving current I11 by a light-receiving signal from the light-receiving element 31 and a current (½)·I11 that is one half of the first light-receiving current I11. The second current distributor 36 outputs a second light-receiving current I12 by a light-receiving signal from the light-receiving element 32. The third current distributor 37 outputs a third light-receiving current I13 by a light-receiving signal from the light-receiving element 33 and a current (½)·I13 that is one half of the third light-receiving current I13. In this case, the light-receiving signal outputted from the first light-receiving element 31 and the light-receiving signal outputted from the third light-receiving element 33 have phases that are mutually different by 180°, and therefore, the first light-receiving current I11 and the third light-receiving current I3 have phases that are mutually different by 180°.

Next, the current (½)·I11 from the first current distributor 35 and the current (½)·I13 from the third current distributor 37 are inputted to the first current-voltage converting part 12 and the third current-voltage converting part 14. Therefore, a current (I11+I13)/2 that is one half of the current (I11+I13) constituted of the DC component obtained by summing up the two first and third light-receiving currents I11 and I13 of which the phases are mutually different by 180° is inputted to the first and third current-voltage converting parts 12 and 14, and a DC signal obtained by converting the summation current (I11+I13)/2 into a voltage is outputted to the first and second differential amplifiers 16 and 17. The first and third current-voltage converting parts 12 and 14 and the first and third current distributors 35 and 37 constitute a first output part.

On the other hand, the first light-receiving current I11 from the first current distributor 35 is inputted as an AC component to the second current-voltage converting part 13. Therefore, the second current-voltage converting part 13 converts the first light-receiving current I11 into a voltage and outputs a first AC signal containing an AC component to the first differential amplifier 16.

Moreover, the second light-receiving current I12 from the second current distributor 36 is inputted as an AC component to the fourth current-voltage converting part 15. Therefore, the fourth-current-voltage converting part 15 converts the second light-receiving current I12 into a voltage and outputs a second AC signal containing an AC component to the second differential amplifier 17.

The first differential amplifier 16 performs comparing operation of the DC signal from the first current-voltage converting part 12 with the first AC signal from the second current-voltage converting part 13 and outputs a signal of an amplified difference between both of them to the first AD converting part 18. The second differential amplifier 17 performs comparing operation of the DC signal from the third current-voltage converting part 14 with the second AC signal from the fourth current-voltage converting part 15 and outputs a signal of an amplified difference between both of them to the second AD converting part 20. As a result, the first AD converting part 18 outputs a first digital signal 41, and the second AD converting part 20 outputs a second digital signal 42.

According to the present embodiment, the two digital signals 41 and 42, of which the duty ratio is 50% and the phases are mutually different by approximately 90°, are obtained from the first and second AD converting parts 18 and 20. In the present embodiment, one half of the summation current (I11+I13) was converted into the voltage and served as the DC signal. With this arrangement, the light-receiving areas of the first AC signal, the second AC signal and the DC signal can be equalized, and the duty ratio of the two digital signals 41 and 42 becomes 50%. Therefore, the first and second differential amplifiers 16 and 17 can perform the comparing operation without offsetting the first and second AC signals and the DC signal.

According to the present embodiment, the DC signal to be subjected to comparison is one for the first AC signal outputted from the second current-voltage converting part 13 and the second AC signal outputted from the fourth current-voltage converting part 15, so that the DC signal is used in common. Therefore, according to the present embodiment, it becomes possible to reduce the light-receiving area for the DC signal. In concrete, a total (¾)P of the widths (¼)P of the first through third light-receiving elements 31 through 33 can be made narrower than one pitch P of the moving object 6. Moreover, by using in common the DC signal that becomes a comparison signal, the influences of the scattering, variation and so on of light can be reduced, and variations in the signals outputted from the first and second differential amplifiers 16 and 17 that constitute the comparing parts can be reduced. Therefore, according to the present embodiment, a compact low-cost optical encoder capable of avoiding the reduction in the SN ratio due to the DC component of the light-receiving signal can be provided.

### Third Embodiment

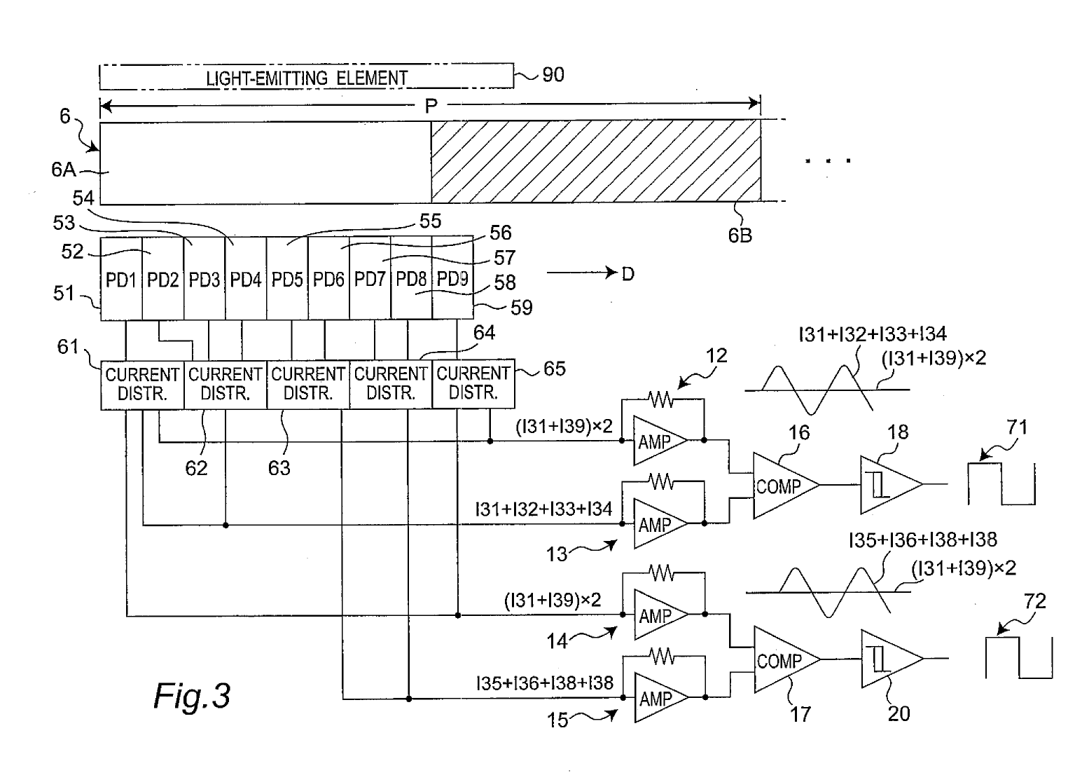

Next, FIG. 3 schematically shows the construction of an optical encoder as a third embodiment of the present invention. The third embodiment differs from the first embodiment in that nine light-receiving elements 51 through 59 are provided in place of the five light-receiving elements 1 through 5 of FIG. 1A and that five current distributors 61 through 65 are provided in place of the five current distributors 7 through 11 of FIG. 1A. Therefore, components similar to those of the first embodiment are denoted by same reference numerals, and the points different from the first embodiment are mainly described.

In the present embodiment, the nine light-receiving elements 51 through 59 arranged in the direction corresponding to the moving direction D of the moving object 6 have a dimension (width) in a direction corresponding to the moving direction D, the dimension being one sixteenth of the array pitch P of the slit 6A of the moving object 6.

The first current distributor 61 receives a first light-receiving signal inputted from the first light-receiving element 51 and outputs a first light-receiving current I31 by a first light-receiving signal and a current 2-I31 that is two times of the first light-receiving current I31. The second current distributor 62 receives second, third and fourth light-receiving signals inputted from the second, third and fourth light-receiving elements 52, 53 and 54 and outputs a current (I32+I33+I34) obtained by summing up second, third and fourth light-receiving currents I32, I33 and I34 by the second, third and fourth light-receiving signals.

Moreover, the third current distributor 63 receives fifth and sixth light-receiving signals inputted from the fifth and sixth light-receiving elements 55 and 56 and outputs a current (I35+I36) obtained by summing up fifth and sixth light-receiving currents I35 and I36 by the fifth and sixth light-receiving signals. The fourth current distributor 64 receives seventh and eighth light-receiving signals inputted from the seventh and eighth light-receiving elements 57 and 58 and outputs a current (I37+I38) obtained by summing up seventh and eighth light-receiving currents I37 and I38 by the seventh and eighth light-receiving signals. The fifth current distributor 65 receives a ninth light-receiving signal inputted from the ninth light-receiving element 59 and outputs a current 2-I39 that is two times of a ninth light-receiving current I39 by the ninth light-receiving signal.

In this case, the light-receiving signal outputted from the first light-receiving element 51 and the light-receiving signal outputted from the ninth light-receiving element 59 have phases that are mutually different by 180°, and therefore, the first light-receiving current I31 and the ninth light-receiving current I39 have phases that are mutually different by 180°.

Next, the current 2·I31 that is two times of the first light-receiving current I31 from the first current distributor 61 and the current 2·I39 that is two times of the light-receiving current I39 from the fifth current distributor 61 are inputted to the first current-voltage converting part 12 and the third current-voltage converting part 14. Therefore, a current (I31+I39)×2 that is two times of the current (I31+I39) constituted of a DC component obtained by summing up the two first and ninth light-receiving currents I31 and I39 of which the phases are mutually different by 180° is inputted to the first and third current-voltage converting parts 12 and 14. Then, the first and third current-voltage converting parts 12 and 14 output a DC signal obtained by converting the doubled current (I31+I39)×2 into a voltage to the first and second differential amplifiers 16 and 17. The first and third current-voltage converting parts 12 and 14 and the first and fifth current distributors 61 and 65 constitute a first output part.

On the other hand, a summation current (I31+I32+I33+I34) as an AC component obtained by summing up the first light-receiving current I31 and the summation current (I32+I33+I34) from the first and second current distributors 61 and 62 is inputted to the second current-voltage converting part 13. Therefore, the second current-voltage converting part 13 converts the summation current (I31+I32+I33+I34) into a voltage and outputs a first AC signal containing an AC component to the first differential amplifier 16.

Moreover, a summation current (I35+I36+I37+I38) as an AC component obtained by summing up summation currents (I35+I36) and (I37+I38) from the third and fourth current distributors 63 and 64 is inputted to the fourth current-voltage converting part 15. Therefore, the fourth current-voltage converting part 15 converts the summation current (I35+I36+I37+I38) into a voltage and outputs a second AC signal containing an AC component to the second differential amplifier 17.

The first differential amplifier 16 performs comparing operation of the DC signal from the first current-voltage converting part 12 with the first AC signal from the second current-voltage converting part 13 and outputs a signal of an amplified difference between both of them to the first AD converting part 18. The second differential amplifier 17 performs comparing operation of the DC signal from the third current-voltage converting part 14 with the second AC signal from the fourth current-voltage converting part 15 and outputs a signal of an amplified difference between both of them to the second AD converting part 20. As a result, the first AD converting part 18 outputs a first digital signal 71, and the second AD converting part 20 outputs a second digital signal 72.

According to the present embodiment, the two digital signals 71 and 72, of which the duty ratio of 50% and the phases are mutually different by approximately 90°, are obtained from the first and second AD converting parts 18 and 20. In the present embodiment, double of the summation current (I31+I39) was converted into a voltage and served as a DC signal. With this arrangement, the light-receiving areas of the first AC signal, the second AC signal and the DC signal can be equalized, and the duty ratio of the two digital signals 71 and 72 becomes 50%. Therefore, the first and second differential amplifiers 16 and 17 can perform the comparing operation without offsetting the first and second AC signals and the DC signal.

According to the present embodiment, the DC signal to be subjected to comparison is one for the first AC signal outputted from the second current-voltage converting part 13 and the second AC signal outputted from the fourth current-voltage converting part 15, so that the DC signal is used in common. Therefore, according to the present embodiment, it becomes possible to reduce the light-receiving area for the DC signal. In concrete, a total (9/8)P of the widths ( 1/16)P of the first through ninth light-receiving elements 51 through 59 can be made narrower than one pitch P of the moving object 6. Moreover, by using in common the DC signal that becomes a comparison signal, the influences of the scattering, variation and so on of light can be reduced, and variations in the signals outputted from the first and second differential amplifiers 16, 17 that constitute the comparing parts can be reduced. Therefore, according to the present embodiment, a compact low-cost optical encoder capable of avoiding the reduction in the SN ratio due to the DC component of the light-receiving signal can be provided.

In the first through third embodiments, the variations in the quantities of received light to the light-receiving elements can be reduced by performing gain adjustment by a gain resistor or the like in the current-voltage converting parts 12 through 15. Moreover, although the comparing parts are constructed of the differential amplifiers in the first through third embodiments, the comparing parts may be each constructed of a comparator. Moreover, according to electronic equipment having the optical encoder of any one of the first through third embodiments, compact low-cost electronic equipment having the optical encoder that has excellent operation accuracy even if the quantity of received light fluctuates mainly when used with low resolving power and is able to output signals of small variations results.

Moreover, although the first, second and third embodiments have the five, three and nine light-receiving elements of (⅛)P width, (¼)P width and ( 1/16)P width, respectively, it is acceptable to provide four light-receiving elements of (⅙)P width, six light-receiving elements of ( 1/10)P width or ten light-receiving elements of ( 1/18)P width. It is noted that, assuming n is an even number of not smaller than four (4, 6, 8, 10, 12, . . . ), when a number {(n/2)+1} of light-receiving elements of (1/n)P width are provided, the first and third current-voltage converting parts 12 and 14 that constitute the first output part output a DC signal, which is obtained by amplifying by (n/8) times the summation current obtained by summing up the light-receiving currents by the light-receiving signals outputted from the light-receiving elements located at opposite ends, to the first and second differential amplifiers 16 and 17. Moreover, the second current-voltage converting part 13 that constitutes the second output part outputs an AC signal containing an AC component, which is obtained by summing up the light-receiving currents by the light-receiving signals outputted from a number (n/4) of light-receiving elements out of a number (n/2) of light-receiving elements which are defined by excluding either one of the light-receiving elements located at opposite ends of the array among the number {(n/2)+1} of light-receiving elements, to the first differential amplifier 16. On the other hand, the fourth current-voltage converting part 15 outputs an AC signal containing an AC component, which is obtained by summing up the light-receiving currents by the light-receiving signals outputted from the remaining number (n/4) of light-receiving elements, to the second differential amplifier 17.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An optical encoder having a light-emitting element, and a plurality of light-receiving elements arranged side by side in one direction in a region that light from the light-emitting element can reach, for detecting movement of a moving object, which has an light-on portion that produces a state in which the light is incident on the light-receiving elements when the light-on portion passes through a prescribed position corresponding to the light-receiving elements and an light-off portion that produces a state in which the light is incident on the light-receiving elements when the light-on portion passes through the prescribed position corresponding to the light-receiving elements, with the light-on portion and the light-off portion alternately passing through the prescribed position when moving in the one direction, the optical encoder comprising:
a first output part which outputs a DC signal comprised of a DC component by summing up two light-receiving signals whose phases are mutually different by 180° out of a plurality of light-receiving signals outputted from the plurality of light-receiving elements;
a second output part to which at least one light-receiving signal out of the plurality of light-receiving signals is inputted and which outputs an AC signal containing an AC component obtained from the inputted light-receiving signal; and
a comparing part to which the DC signal from the first output part and the AC signal from the second output part are inputted and which compares the DC signal with the AC signal and outputs a signal that represents a result of the comparison.

2. The optical encoder as claimed in claim 1, wherein
the second output part generates the AC signal by summing up the plurality of light-receiving signals.

3. The optical encoder as claimed in claim 1, wherein
one light-receiving signal of the two light-receiving signals inputted to the first output part is inputted to the second output part.

4. The optical encoder as claimed in claim 1, further comprising:
assuming n is an even number of not smaller than two, a number {(n/2)+1} of light-receiving elements arranged in a direction corresponding to the moving direction of the moving object, wherein
the light-receiving elements have a dimension in the direction corresponding to the moving direction of the moving object, the dimension being one n-th of an array pitch of the light-on portion and the light-off portion of the moving object, and
the first output part outputs the DC signal comprised of the DC component by summing up light-receiving signals outputted from two light-receiving elements located at opposite ends of the array of the number {(n/2)+1} of light-receiving elements.

5. The optical encoder as claimed in claim 4, wherein
the number n is an even number of not smaller than four,
the first output part outputs the DC signal by amplifying by (n/8) times a summation signal obtained by summing up the light-receiving signals, and
the second output part outputs the AC signal containing the AC component obtained from the light-receiving signals outputted from a number (n/4) of light-receiving elements out of a number (n/2) of light-receiving elements which are defined by excluding either one of the two light-receiving elements located at opposite ends of the array among the number {(n/2)+1} of light-receiving elements.

6. The optical encoder as claimed in claim 1, wherein
at least one of the first and second output parts comprises a plurality of amplifiers and a current mirror circuit that distributes light-receiving signals to the plurality of amplifiers.

7. Electronic equipment comprising the optical encoder claimed in claim 1.
